(19) United States
(12) Patent Application Publication
(10) Pub. No.: US 2023/0159180 A1
(43) Pub. Date: May 25, 2023

(54) METHOD FOR MANAGING THE AMOUNTS OF POWER DRAWN FROM POWER UNITS OF THE PROPULSION UNITS OF AN AIRCRAFT

(71) Applicants: Airbus (S.A.S.), Blagnac (FR); Airbus Operations (S.A.S.), Toulouse (FR)

(72) Inventors: Patrick Zaccaria, Blagnac (FR); Pierre Daste, Toulouse (FR); Paul-Emile Roux, Toulouse (FR); Didier Poirier, Blagnac (FR); Guillaume Alix, Toulouse (FR); David Boyer, Toulouse (FR); Lucie Coue, Toulouse (FR); Souhaib Boukayoua, Toulouse (FR)

(21) Appl. No.: 17/991,101

(22) Filed: Nov. 21, 2022

(30) Foreign Application Priority Data
Nov. 22, 2021 (FR) 2112353

(51) Int. Cl. B64D 31/06

(52) U.S. Cl. CPC B64D 31/06; B64D 2221/00

(57) ABSTRACT

A method for managing power drawn from power units of propulsion units of an aircraft, wherein the method includes a step of increasing the amount of power drawn from a second power unit that is time shifted, with respect to a step of increasing the amount of power drawn from a first power unit, for a duration that at least allows the operational state or the non-operational state of the first power unit to be determined. This solution allows simultaneous switching to the non-operational state of the two power units to be avoided.

### TECHNICAL FIELD

The disclosure herein relates to a method for managing the amounts of power drawn from power units of the propulsion units of an aircraft.

### BACKGROUND

According to an embodiment illustrated in FIG. 1, an aircraft 10 comprises a fuselage 12, wings 14 disposed on either side of the fuselage 12, and also propulsion units 16 connected to the wings 14 and positioned on either side of the fuselage 12. Each propulsion unit 16 comprises a power unit, such as a turbojet engine, for example, a pneumatic power drawing system, such as a compressor, for example, at least one mechanical power drawing system, such as an alternator, for example, and also various supplementary items of equipment, such as hydraulic pumps or a cooling system, for example, intended for the proper operation of the propulsion unit 16. The aircraft 10 generally comprises other power sources, such as an auxiliary power unit 18, batteries 20, or the like.

The aircraft 10 also comprises a plurality of electrical loads, such as the avionics systems of the aircraft or the flight controls of the aircraft, for example, using electrical energy, and also a plurality of pneumatic loads, such as the conditioned-air management system, for example, using pneumatic energy.

As illustrated in FIG. 2, the actual energy requirements 22 of the electrical and pneumatic loads vary as a function of time.

Since the electrical or pneumatic loads of the aircraft are not attached to the same power units, the amounts of power that are drawn, and also the variations in the amounts of power that are drawn, can differ from one power unit to another as a function of the electrical or pneumatic loads, resulting in an increase in the energy requirements.

Each propulsion unit 16 comprises its own control unit, which is configured to manage the engine speed of its power unit, and also the power generated by the unit, and to direct it as a function of the energy requirements.

According to an operating logic, each power unit operates at an engine speed 24 that is set to a constant value V0 allowing it to provide the energy needed to supply all the electrical and pneumatic loads of the aircraft, irrespective of their actual energy requirements. According to this operating logic, the value V0 is high, which results in high energy consumption for the aircraft.

Document FR 3099526 proposes a method for controlling the engine speeds of the power units of the various aircraft propulsion units, and also the power draws from the power units. This method comprises a step of determining the actual energy requirements of the aircraft in real time, and also a step of adapting, if necessary, the engine speed of at least one power unit as a function of the variation in the actual energy requirements. For at least one power unit, its engine speed 26 is initially set to a value V1, corresponding to a first power drawing capacity, allowing it to meet the actual energy requirements when the requirements are substantially at a first average level N1. When the actual energy requirements increase to a second average level N2, the method comprises a step of increasing the engine speed 26 to a second value V2 that is determined so that the power drawing capacity of the power unit is sufficient to cover the actual energy requirements corresponding to the second average level N2.

Since the change in the engine speed is not instantaneous, a power draw 28 from another power source, such as the batteries 20, for example, can be carried out.

The method described in FR 3099526 allows the energy consumption of the aircraft to be substantially reduced by setting the engine speed of the power units of the aircraft propulsion units as accurately as possible so that the total capacity for drawing power from the power units is adapted to the actual energy requirements and so that it does not, for most of the time, significantly exceed these requirements.

Increasing the actual energy requirements can require adaption of the amount of power drawn from one or more power units.

It is imperative that these changes in the amount of power drawn from one or more power unit(s) are safeguarded so that they do not cause the simultaneous malfunction of a plurality of power units.

### SUMMARY

An aim of the disclosure herein is a solution for safeguarding the adaptation of the engine speed of the power units in order to meet the actual energy requirements.

To this end, the aim of the disclosure herein is a method for managing the amounts of power drawn from power units of the propulsion units of an aircraft,
each power unit being configured to assume an operational state or a non-operational state and having a power drawing capacity,
the aircraft comprising at least first and second power units, which for a flight require a minimum number of power units in the operational state and which have actual energy requirements,
the method comprising a step of increasing the amounts of power drawn from at least the first and second power units due to an increase in the actual energy requirements of the aircraft.

According to the disclosure herein, the method comprises a step of increasing the amount of power drawn from the second power unit that is time shifted, with respect to a step of increasing the amount of power drawn from the first power unit, for a duration that at least allows the operational state or the non-operational state of the first power unit to be determined.

Time shifting the increase in the amount of power drawn from the two power units prevents the two power units from simultaneously switching to the non-operational state, which could result in flight safety being affected.

According to another feature, the state of the first power unit is checked following a determined delay, of the order of a few seconds, after the increase in the amount of power drawn from the first power unit.

According to another feature, the step of increasing the amount of power drawn from the second power unit is carried out only:
if the first power unit is in the operational state following the increase in the power drawn from this first power unit,
or, otherwise, if the determined number of power units in the operational state, without taking into account the state of the second power unit, is greater than or equal to the minimum number of power units in the operational state required for a flight.

According to another feature, the power unit from among the power units of the aircraft that first receives a request for an increase in the amount of power drawn remains the priority throughout the method, with the increase in the amount of power drawn from the power unit that first received the request for an increase being triggered first.

According to another feature, the power unit from among the power units of the aircraft having first reached the power drawing capacity adapted to a request to increase the amount of power remains the priority throughout the method, with the increase in the amount of power drawn from the priority power unit being triggered first.

### BRIEF DESCRIPTION OF THE DRAWINGS

Further features and advantages will become apparent from the following description of the disclosure herein, which description is provided solely by way of an example, with reference to the accompanying drawings, in which:

FIG. 1 is a top view of an aircraft;

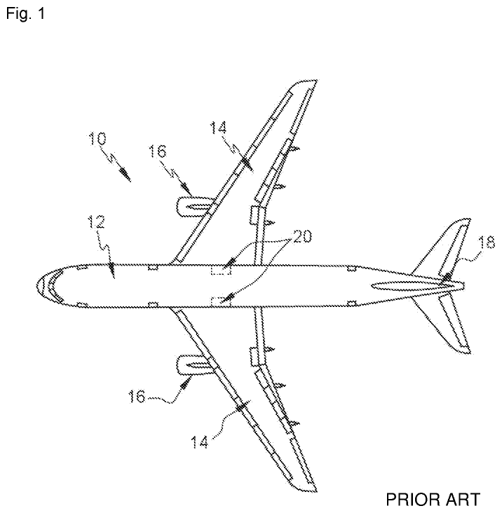

FIG. 2 is a representation of the engine speed of a power unit and of the actual energy requirements of an aircraft illustrating an embodiment of the prior art;

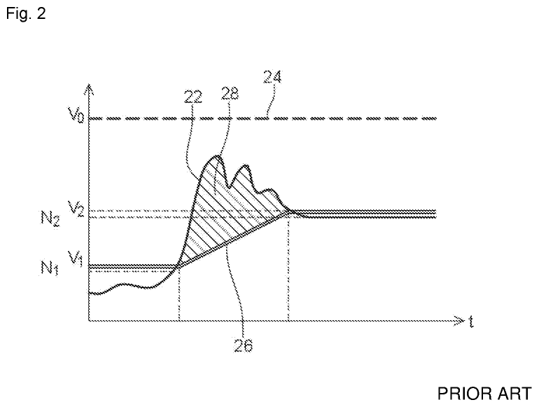

FIG. 3 is a schematic representation of a device for managing the amounts of power drawn from power units of the propulsion units of an aircraft illustrating an embodiment of the disclosure herein;

FIG. 4 is a schematic representation of the power drawn from power units of the propulsion units of an aircraft illustrating a first operating mode,

FIG. 5 is a schematic representation of the power drawn from power units of the propulsion units of an aircraft illustrating a first example of a second operating mode; and

FIG. 6 is a schematic representation of the power drawn from power units of the propulsion units of an aircraft illustrating a second example of the second operating mode.

### DETAILED DESCRIPTION

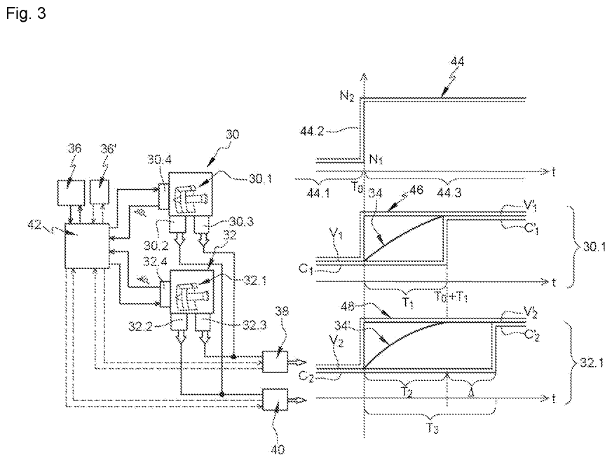

As illustrated in FIG. 3, an aircraft comprises at least two propulsion units 30, 32 each comprising a power unit 30.1, 32.1, such as a turboshaft engine or a turbojet engine, for example, at least one pneumatic power drawing system 30.2, 32.2, such as a compressor, for example, at least one mechanical power drawing system 30.3, 32.3, such as an alternator, for example, and also various supplementary items of equipment, such as hydraulic pumps or a cooling system, for example, intended for the proper functioning of the propulsion unit 30, 32.

According to one design, each propulsion unit 30, 32 comprises at least a first mechanical power drawing system 30.3, 32.3 intended for the aircraft, converting mechanical energy into electrical energy and performing the function of an electrical power source for the aircraft, and also at least a second mechanical power drawing system (not shown) intended for the propulsion unit 30, 32 and in particular for its supplementary items of equipment.

Each propulsion unit 30, 32 comprises a control unit 30.4, 32.4 for managing the operation of the power unit 30.1, 32.1, and also pneumatic, electrical and/or mechanical power drawing systems. Thus, the control unit 30.4, 32.4 is configured to control the engine speed of the power unit 30.1, 32.1. For a given engine speed, the power unit 30.1, 32.1 is capable of providing a power drawing capacity 34, 34′ that corresponds to the maximum value of the power that can be drawn from the power unit 30.1, 32.1.

The power units 30, 32 are not described further as they may be identical to those of the prior art.

Each aircraft comprises a given number of propulsion units. It is configured to be able to fly with a minimum number Mmin of power units in the operational state. By way of example, in the case of an aircraft comprising two propulsion units, the minimum number Mmin of operational power units to complete its mission is equal to 1. For an aircraft having four propulsion units, the minimum number Mmin of operational power units to be able to fly could, for example, be equal to 2 or 3 depending on the current regulations.

Each power unit 30.1, 32.1 is configured to assume an operational state, in which it can be included among the minimum number Mmin of power units in the operational state required for a flight, and a non-operational state, in which it cannot be included among the minimum number Mmin of power units in the operational state required for a flight.

According to one configuration, for each propulsion unit 30, 32, its control unit 30.4, 32.4 is configured to determine or to indicate the operational or non-operational state of the associated power unit 30.1, 32.1. By way of an example, when the power unit is a turbojet engine, the engine can be equipped with a sensor configured to determine the speed of rotation of its axis of rotation. If the value measured by the sensor for the speed of rotation is zero or does not correspond to that of the engine speed, then the control unit 30.4, 32.4 can deduce therefrom that the turbojet engine is in the non-operational state. Of course, the disclosure herein is not limited to this measure or to this criterion for determining the operational or non-operational state of a power unit 30.1, 32.1.

The aircraft also comprises:
at least one avionics system ensuring, among other things, the control of certain items of electrical, hydraulic and pneumatic equipment of the aircraft;
at least one electrical unit that has, in addition to the first mechanical power drawing systems 30.3, 32.3 of the propulsion units 30, 32, at least one supplementary power source 36, 36′, such as an auxiliary power unit 36 (APU) or batteries 36′, for example, at least one electrical load 38, at least one electrical network connecting each electrical load 38 to at least one of the electrical power sources 30.3, 32.3, 36, 36′;
at least one pneumatic unit that has, in addition to the pneumatic power drawing system 30.2, 32.2 of each propulsion unit 30, 32, at least one pneumatic load 40, such as a cabin air conditioning system, for example, and at least one pneumatic network connecting each pneumatic load 40 to at least one of the pneumatic power sources 30.2, 32.2.

The auxiliary power unit 36 can comprise a pneumatic power drawing system performing the function of a pneumatic power source.

By way of example, the electrical unit can comprise a plurality of electrical loads 38, such as the avionics system, an engine for moving the aircraft on the ground, electrical equipment for the aircraft cabin, or any other electrical load.

According to one embodiment, the batteries 36′ are rechargeable and the electrical unit comprises a battery management system configured to manage the load of the batteries 36′.

All these elements of the aircraft are not described further as they may be identical to those of the prior art.

The aircraft comprises at least one centralized control system 42 configured to manage a plurality of pneumatic, electrical, and/or mechanical power sources 30.2, 30.3, 32.2, 32.3, 36, 36′ as a function of the power required, in particular by the aircraft thrust and the pneumatic and/or electrical loads 38, 40. The centralized control system 42 can be integrated in the aircraft avionics system.

During operation, the aircraft comprises actual energy requirements 44, corresponding to the sum of the energy consumed by the pneumatic, electrical and/or mechanical loads, which change as a function of time. By way of example, the actual energy requirements 44 can have at least one first plateau phase 44.1, during which the actual energy requirements 44 remain within a given range and have a first average level N1, at least one variation 44.2, during which the actual energy requirements 44 vary beyond the given range, and at least one second plateau phase 44.3, during which the actual energy requirements 44 remain within a given range and have a second average level N2 greater than the first average level N1.

According to one arrangement, the pneumatic, electrical and/or mechanical loads of the aircraft are not attached to the same power units. Thus, the power required for operating a pneumatic, electrical and/or mechanical load is drawn from at least one power unit, which can be different to that from which the power required for another load is drawn. Consequently, the amounts of power drawn, and also the variations in the amounts of power drawn, can differ from one power unit to another as a function of the pneumatic, electrical and/or mechanical loads leading to the increase in energy requirements.

During the first plateau phase 44.1, the actual energy requirements 44 are drawn from a first power unit 30.1 operating at a first engine speed set to a first value V1, which allows it to have a first power drawing capacity C1, and also from a second power unit 32.2 operating at a second engine speed set to a second value V2, which allows it to have a second power drawing capacity C2. The engine speeds of the various power units 30.1, 32.1 of the aircraft are set so that the power drawing capacity C1, C2 of each power unit 30.1, 32.1 is greater than the actual energy requirements 44 of the pneumatic and/or electrical loads 38, 40 connected to the power unit.

For each power unit 30.1, 32.1, its power drawing capacity is a function of the value of its engine speed.

As described in document FR 3099526, a method for managing engine speeds and power draws comprises a step of determining actual energy requirements 44 of the aircraft in real time, a step of determining a power drawing capacity for each power unit 30.1, 32.1 in real time, a step of comparing, for each power unit 30.1, 32.1, the actual energy requirements 44 of the loads attached to the power unit 30.1, 32.1 in question and the power drawing capacity of the power unit 30.1, 32.1 in question of the aircraft and, as a function of this comparison, a step of setting the power drawing capacity of at least two power units if, for each of these two power units 30.1, 32.1, the actual energy requirements of the loads attached to either one of these two power units 30.1, 32.1 are higher than the power drawing capacity of the power unit 30.1, 32.1.

According to one embodiment, the centralized control system 42 knows the energy consumption of all the pneumatic, electrical and/or mechanical loads in real time and determines the actual energy requirements 44 assigned to each power unit of the aircraft in real time, and also the power drawing capacities of each power unit 30.1, 32.1. According to one configuration, the control unit 30.4, 32.4 of each propulsion unit transmits the power drawing capacity of the power unit 30.1, 32.1 of the propulsion unit 30, 32 in question to the centralized control system 42 in real time.

Irrespective of the embodiment, the centralized control unit 42 is configured to determine a variation 44.2 in the actual energy requirements 44 in real time or in advance.

Following the detection of the variation 44.2 in the actual energy requirements 44, the centralized control system 42 determines, for each power unit 30.1, 32.2 affected, a new power drawing capacity C1′, C2′ and the associated new engine speed V1′, V2′.

As illustrated in FIG. 3, one of the propulsion units 30, 32 is first called upon for this adaptation. For the remainder of the description, the first propulsion unit 30 is called upon first. Of course, in other circumstances, the second propulsion unit 32 could be called upon first.

The order for calling upon the propulsion units can be stipulated by the centralized control system 42 or can vary depending on the circumstances, for example, depending on the electrical and/or pneumatic networks or the electrical and/or pneumatic loads 38, 40 that are newly activated or require excess energy.

The centralized control system 42 transmits a first command to increase the engine speed of its power unit 30.1 to the first propulsion unit 30 that is called upon so that the engine speed reaches the new first value V1′ corresponding to the new power drawing capacity C1′.

As illustrated in FIG. 3, the change in engine speed is gradual between the first value V1 and the new first value V1′ and requires a duration T1. Since this change in engine speed is gradual, the centralized control system 42 commands a power draw 46 from at least one supplementary power source 36, 36′, such as from the batteries 36′, for example. This power draw 46 is provided at least for the duration T1 required for the power unit 30.1 to reach its new power drawing capacity C1′.

According to one configuration, the centralized control system 42 transmits a command to gradually increase the power draw from the first power unit 30.1 to the first propulsion unit 30, with the gradual increase following the gradual increase in the power drawing capacity of the first power unit 30.1. According to this configuration, the amount of power drawn from the first power unit gradually increases between the instants T0 and T0+T1. In parallel, the amount of power drawn from the supplementary power source 36, 36′ gradually decreases.

According to another configuration, the amount of power drawn from the first power unit 30.1 remains constant as long as its engine speed has not reached the new value V1′ and its power drawing capacity has not reached the new value C1′ at the instant T0+T1. Thus, during the duration T1, the amount of power drawn from the one (or more) supplementary power source(s) 36, 36′ is constant.

According to this other configuration, when the first power unit 30.1 has reached its new engine speed V1′, the centralized control system 42 transmits a first command to the first propulsion unit 30 to increase the amount of power drawn from the first power unit 30.1, so that the amount of power drawn from the first power unit 30.1 corresponds to the new actual energy requirements 44.

According to a feature of the disclosure herein, the centralized control system 42 determines the operational or non-operational state of the first power unit 30.1 after the change in the amount of power drawn from the first power unit 30.1 corresponding to the new actual energy requirements 44.

According to one configuration, in addition to knowing the operational or non-operational state of the first power unit 30.1, the centralized control system 42 determines the number of power units in the operational state.

According to an operating mode shown in FIG. 3, the centralized control system 42 transmits a second command to the second propulsion unit 32 to increase the engine speed of its power unit 32.1, so that its engine speed reaches the new second value V2′ corresponding to the new power drawing capacity C2′ to be reached for the second power unit 32.1.

As illustrated in FIG. 3, the change in engine speed is gradual between the second value V2 and the new second value V2′ and requires a duration T2, optionally equal to the duration T1. Since this change in engine speed is gradual, the centralized control system 42 commands a power draw 48 from at least one supplementary power source 36, 36′, such as the batteries 36′, for example. This power draw 48 is provided for a duration T3 longer than the duration T2.

When the second propulsion unit 32 has reached its new power drawing capacity C2′, the centralized control system 42 determines or checks the operational state or the non-operational state of the first power unit 30.1. According to a first embodiment, if the first power unit 30.1 is in the non-operational state, then the centralized control system 42 does not transmit a second command to the second propulsion unit to increase the amount of power drawn from the second power unit 32.1, even if this is allowed by the power drawing capacity of the second power unit 32.1. As a variant, if the first power unit 30.1 is in the non-operational state, the centralized control system 42 transmits the second command to increase the amount of power drawn from the second power unit 32.1 to the second propulsion unit only if the number of power units in the operational state, without taking into account the second power unit 32.1, is greater than or equal to the minimum number Mmin of power units in the operational state required for a flight.

If the first power unit 30.1 is in the operational state or if the first power unit 30.1 is in the non-operational state but the number of power units in the operational state, without taking into account the second power unit 32.1, is greater than or equal to the minimum number Mmin of power units in the operational state required for a flight, then the centralized control system 42 transmits a second command to the second propulsion unit 32 to increase the amount of power drawn from the second power unit 32.1, in order that the amount of power drawn from the second power unit 32.1 corresponds to the new actual energy requirements 44. Thus, this second command to increase the amount of power drawn from the second power unit 32.1 is time shifted with respect to the first command to increase the amount of power drawn from the first power unit 30.1 by a duration A. In this case, the duration T3 during which an amount of power is drawn from at least one supplementary power source 36, 36′ is at least equal to the duration T1 increased by the duration A.

The state of the first power unit 30.1 is checked following a determined delay, of the order of a few seconds, after the amount of power drawn from the first power unit 30.1 has been increased. This delay makes it possible to be certain that the increase in the amount of power drawn from the first power unit has not affected its operational state.

Irrespective of the embodiment, when the amount of power drawn from at least the first and second power units 30, 32 needs to be increased, a step of increasing the amount of power drawn from the second power unit 32.1 is time shifted, with respect to a step of increasing the amount of power drawn from the first power unit 30.1, for a duration that at least allows the operational state or the non-operational state of the first power unit 30.1 to be determined. Time-shifting the increase in the amount of power drawn from the two power units makes it possible to prevent the two power units 30, 32 from simultaneously switching to the non-operational state, which could result in flight safety being affected.

According to a particular feature of the disclosure herein, when, for a first power unit, the amount of power drawn from this first power unit has been increased, prior to a step of increasing the amount of power drawn from this second power unit 32.1, the method comprises a step of determining the operational state or the non-operational state of all the power units and a step of comparing the determined number of power units in the operational state with the minimum number Mmin of power units in the operational state required for a flight, with the step of increasing the amount of power drawn from the second power unit 32.1 being carried out only:
if the first power unit 30.1 is in the operational state after the increase in the power drawn from this first power unit 30.1,
or, otherwise, if the determined number of power units in the operational state, without taking into account the state of the second power unit 32.1, is greater than or equal to the minimum number Mmin of power units in the operational state required for a flight.

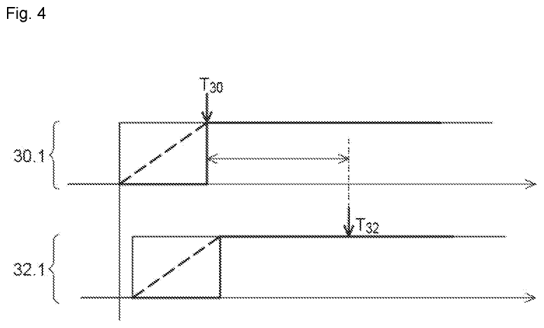

According to a first operating mode illustrated in FIG. 4, the power unit, in particular the power unit 30.1, that first receives the request to increase the amount of power drawn remains the priority throughout the method. Thus, the increase in the amount of power drawn from the first power unit is triggered as a priority at the instant T30. The increase in the amount of power drawn from the second power unit 32.1 is subsequently triggered at the instant T32, in particular if the number of power units in the operational state makes it possible to command this increase in the amount of power drawn from the second power unit 32.1.

According to a second operating mode, the increase in the amount of power drawn is triggered on the power unit that first reaches the engine speed offering the required power drawing capacity.

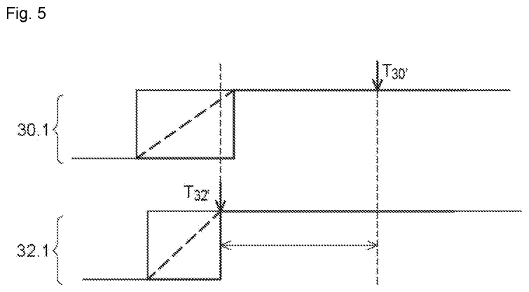

According to a first example illustrated in FIG. 5, the second power unit 32.1 first reaches the power drawing capacity suitable for the future increase in the amount of power drawn at the instant T32′. Consequently, the increase in the amount of power drawn from the second power unit 32.1 is first triggered from this instant T32′. The increase in the amount of power drawn from the first power unit 30.1 is subsequently triggered at the instant T30′, in particular if the number of power units in the operational state makes it possible to command this increase in the amount of power drawn from the first power unit 30.1.

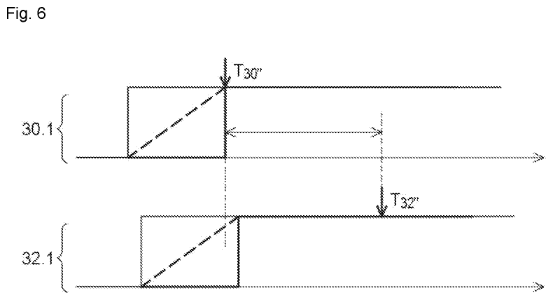

According to a second example illustrated in FIG. 6, the first power unit 30.1 first reaches the power drawing capacity suitable for the future increase in the amount of power drawn at the instant T30″. Consequently, the increase in the amount of power drawn from the first power unit 30.1 is first triggered from this instant T30″. The increase in the amount of power drawn from the second power unit 32.1 is subsequently triggered at the instant T32″, in particular if the number of power units in the operational state makes it possible to command this increase in the amount of power drawn from the second power unit 32.1.

In the event that the step of increasing the amount of power drawn from the second power unit 32.1 is not carried out, the conventional aircraft safety laws are then implemented.

The subject matter disclosed herein can be implemented in or with software in combination with hardware and/or firmware. For example, the subject matter described herein can be implemented in or with software executed by a processor or processing unit. In one example implementation, the subject matter described herein can be implemented using a computer readable medium having stored thereon computer executable instructions that when executed by a processor of a computer control the computer to perform steps. Example computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for managing amounts of power drawn from power units of propulsion units of an aircraft, each power unit being configured to assume an operational state or a non-operational state and having a power drawing capacity, the aircraft comprising at least first and second power units, which for a flight require a minimum number of power units in the operational state and which have actual energy requirements, the method comprising increasing the amounts of power drawn from at least the first and second power units, and the method comprising increasing an amount of power drawn from the second power unit that is time shifted, with respect to increasing the amount of power drawn from the first power unit, for a duration that at least allows the operational state or the non-operational state of the first power unit to be determined.

2. The management method according to claim 1, wherein a state of the first power unit is checked following a determined delay, of a few seconds, after the increase in the amount of power drawn from the first power unit.

3. The management method according to claim 1, wherein increasing the amount of power drawn from the second power unit is carried out only:
if the first power unit is in the operational state after the increase in the power drawn from this first power unit;
or, otherwise, if the determined number of power units in the operational state, without taking into account the state of the second power unit, is greater than or equal to the minimum number of power units in the operational state required for a flight.

4. The management method according to claim 1, wherein the power unit from among the power units of the aircraft that first receives a request for an increase in the amount of power drawn remains a priority throughout the method, with the increase in the amount of power drawn from the power unit that first received the request for an increase being triggered first.

5. The management method according to claim 1, wherein the power unit from among the power units of the aircraft having first reached the power drawing capacity adapted to a request to increase the amount of power remains a priority throughout the method, with the increase in the amount of power drawn from the priority power unit being triggered first.
